(19) United States
(12) Patent Application Publication
(10) Pub. No.: US 2010/0242101 A1
(43) Pub. Date: Sep. 23, 2010

(54) METHOD AND SYSTEM FOR SECURELY MANAGING ACCESS AND ENCRYPTION CREDENTIALS IN A SHARED VIRTUALIZATION ENVIRONMENT

(76) Inventor: George Edward Reese, JR., Maple Grove, MN (US)

Correspondence Address: David Bagley;enStratus Networks LLC, Suite 150, 1201 Marquette Ave S, Minneapolis, MN, 55403, US

(21) Appl. No.: 12/408,671

(22) Filed: Mar. 20, 2009

(51) Int. Cl. G06F 17/30; G06F 15/16; H04L 29/06

(52) U.S. Cl. 726/6

(57) ABSTRACT

A computing system for managing a virtual server includes a machine remote from the virtual server that operates a provisioning service, a credentials server remote from the virtual server, and at least one guest server manager running on a guest host associated with the virtual server. The provisioning service obtains credentials from the credentials server and delivers them to the at least one guest server manager. The server manager acts under the direction of the provisioning service.

### TECHNICAL FIELD

Various embodiments described herein relate to a method and a system for securely managing access and encryption credentials in a shared virtualization environment. More specifically, this relates to managing access and encryption that is provided to a virtual server in a cloud environment.

### BACKGROUND

Cloud computing is an Internet based development for the use of computer technology. In many instances, an entity needs temporary extra capacity to perform a computing task. Rather than buy and maintain a hardware solution, such as a server, sized to handle the computing task, many are submitting the task to existing hardware that is connected to the Internet which is operating at less than full capacity. In some instances, many servers connected to the Internet are formed into a large virtual server which is able to perform the computing task. The concept incorporates software as a service (SaaS), Web 2.0 and other recent, well-known technology trends, in which the common theme is reliance on the Internet for satisfying the computing needs of the users.

The advantages of cloud computing are numerous. The owners of the hardware get a fee for allowing a third party to use their extra computing capacity. This can be used to defray some of the costs associated with owning and maintaining the hardware. The owner of the computing task (renter of the virtual server) gets the computing task done without having to own and maintain a much larger hardware solution. The task gets done more quickly since much more computing hardware can be used to form a virtual server. In other words, the virtual server is generally larger than what the owner of the computing task would have purchased. The owner of the computing task does not have to maintain any hardware since the virtual server or individual servers forming the virtual server are being maintained by their actual owners. The owner of the computing task also does not have to worry about obsolescence of his or her hardware since the hardware is owned by another entity.

Among the shortcomings associated with running computing tasks on a virtual server in “the cloud” is that the owner of the computing task may lose all or part of the control over the data associated with the computing task. Traditional identity management requires placing application credentials in the cloud. When the computing task is completed the virtual server instance is terminated. Depending on the size of the application there may be hundreds or even thousands of actual servers that rapidly disappear from existence. There is no control over what happens to the credentials stored in the cloud as they may be stored on one or more servers forming the virtual server. Similarly, there is also no control over what happens to the data when the virtual server instance is terminated. One solution is to manually grant and remove user access to each server making up the virtual server in the cloud environment. Manually granting and removing user access to the servers that form the virtual server could be very time consuming. If there are many servers forming the virtual server, this solution would be painful. In many instances, the nature of the computing task does not allow the owner of the computing task to lose control over the data. For example, if control over the data is lost, it is conceivable that one or more of the third parties that provided servers to make up the virtual server may have to turn over data in response to an over-broad discovery order in a legal proceeding. This could happen even if the legal proceeding did not involve the owner of the computing task. The result could be merely embarrassing or could be legally devastating.

### SUMMARY

Disclosed is an apparatus and method to enable the secure management of host access and encryption credentials outside of a cloud infrastructure for use within the cloud infrastructure. The apparatus and method makes it possible to store no credentials inside of the virtualization environment of a cloud hosting provider.

### BRIEF DESCRIPTION OF THE DRAWINGS

FIG. 1 is a schematic diagram of a computer system that operates in a cloud computing environment, according to an example embodiment.

FIG. 2 is a schematic diagram of the computing system for managing a virtual server, according to an example embodiment.

FIG. 3 is a flow diagram of a method for managing security in a virtual server, according to an example embodiment.

FIG. 4 is a schematic of the display device, according to an example embodiment.

FIG. 5 is a schematic diagram of a media that includes a set of instructions, according to an example embodiment.

### DETAILED DESCRIPTION

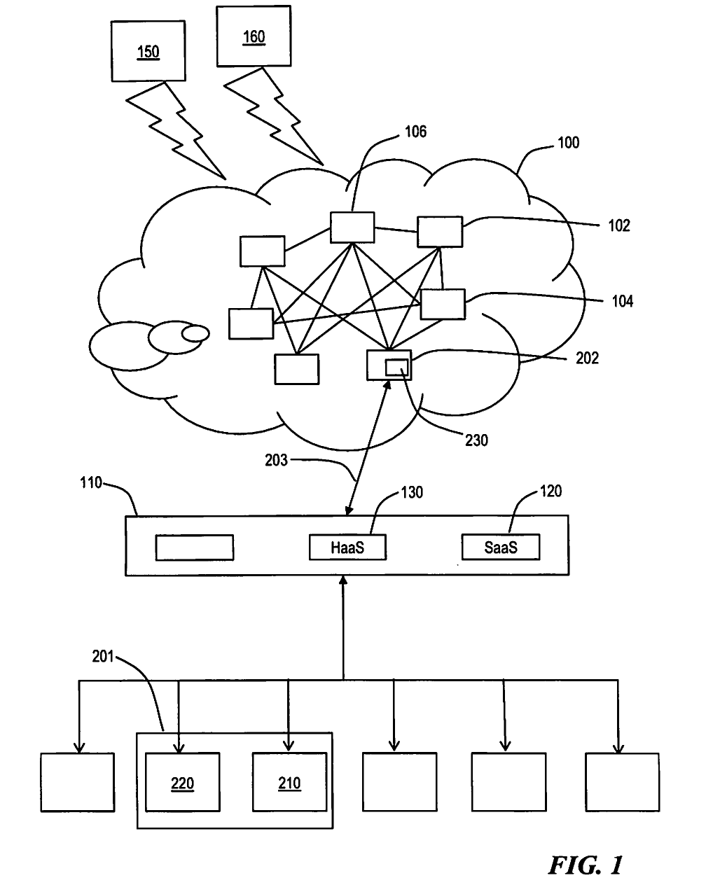

FIG. 1 is a schematic diagram of a computer system 200 that operates in a cloud computing environment 100. The computer system 200 includes a first portion 201 which operates outside of the cloud 100 and a second portion 202 which operates within the cloud 100. A communications channel 203 connects the first portion 201 and the second portion 202. In other words, the first portion 201 outside the cloud 100 communicates with the second portion 202 within the cloud by way of a communications channel 203. The communications channel 203, as shown, in FIG. 1, is a rather direct route between the first portion 201 and the second portion 202. The computer system 200 is one example embodiment of the invention.

The cloud 100 is actually the internet. The Internet is a global network of interconnected computers, such as 102, 104, 106, and 202. The global network of interconnected computers enables users to share information along multiple channels. Typically, a computer that connects to the Internet or cloud 100 can access information from a vast array of available servers and other computers by moving information from them to the computer's local memory. The same connection allows that computer to send information to servers on the network; that information is in turn accessed and potentially modified by a variety of other interconnected computers. A majority of widely accessible information on the Internet or in the cloud 100 includes of inter-linked hypertext documents and other resources of the World Wide Web (WWW). Computer users typically manage sent and received information with web browsers; other software for users' interface with computer networks includes specialized programs for electronic mail, online chat, file transfer and file sharing. FIG. 1 also shows several end users 150, 160 communicatively coupled to the cloud 100.

The movement of information in the Internet is achieved via a system of interconnected computer networks that share data by packet switching using the standardized Internet Protocol Suite (TCP/IP). It is a “network of networks” that includes of millions of private and public, academic, business, and government networks of local to global scope that are linked by copper wires, fiber-optic cables, wireless connections, and other technologies.

Cloud computing is an Internet based development for the use of computer technology. The cloud 100 or internet includes extra capacity to do many computing tasks. There is hardware for storing data (cloud storage), hardware for executing computing tasks (cloud platforms), and the like. In many instances computing resources are operating at less than full capacity. In many instances, an entity needs temporary extra capacity to perform a computing task. Rather than buy and maintain a hardware solution, such as a server, sized to handle the computing task, many are submitting the task to existing hardware that is connected to the Internet or which is part of the cloud 100. In one instance, the entity needing the extra computing capacity rents or leases the extra capacity in the cloud 100. This model is similar to a utility company selling power and therefore, sometimes cloud computing is referred to as utility computing. In other instances, the extra resources are given away. In some instances, many servers connected to the Internet are formed into a large virtual server which is able to perform the computing task. The large virtual server may be made up of one server or many servers having extra capacity and linked to the internet (i.e. within the cloud 100).

The cloud requires an interface 110 that includes infrastructure to allow use of the cloud 100 for cloud computing. The infrastructure 110 incorporates software as a service (SaaS) 120, Web 2.0, hardware as a service (Haas) 130 and other recent, well-known technology trends, in which the common theme is reliance on the Internet for satisfying the computing needs of the users. FIG. 1 shows that the computing portion 201 that operates outside the cloud 100 includes software and hardware that form a provisioning server 210 that executes a set of instructions to provide a provisioning service, and a credentials server 220 for storing credentials needed to do computing tasks. The credentials may be access credentials and encryption keys.

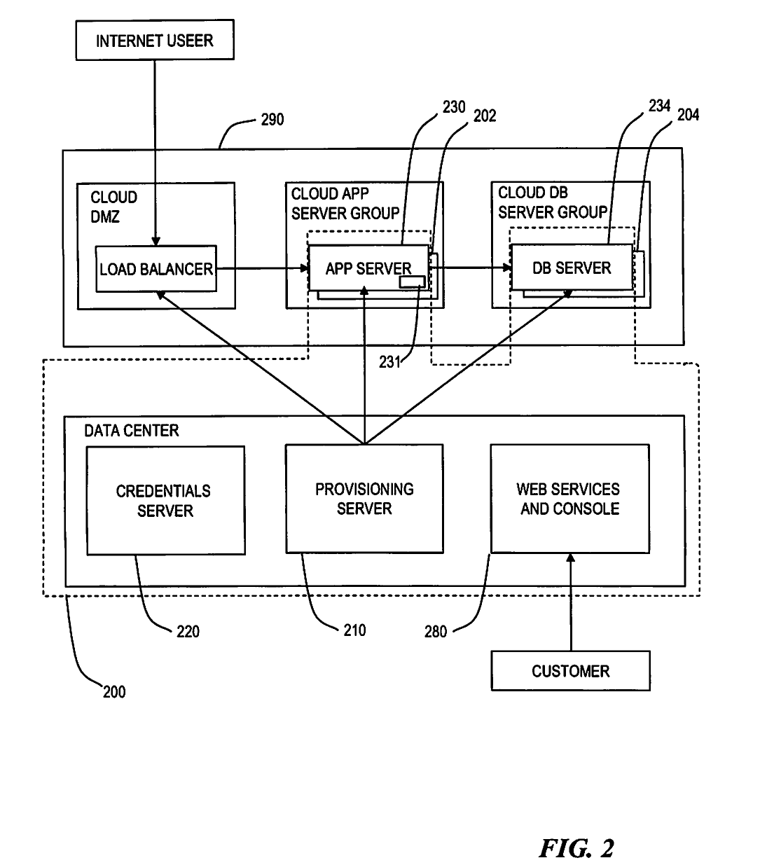

FIG. 2 is a schematic diagram of the computing system 200 for managing a virtual server 290. The computing system 200 includes a machine 210 remote from the virtual server 290 (which is comprised of one or more servers from the internet) that operates a provisioning service, a credentials server 220 remote from the virtual server 230, and at least one guest server manager running on a guest host 202 associated with the virtual server 290. The provisioning service run by the provisioning server 210 obtains credentials from the credentials server 220 and delivers them to the at least one guest server manager. The server manager 230 acts under the direction of the provisioning server 210 that runs the provisioning service. The server manager 230 runs on a guest host 202 associated with the virtual server 290. The server manager 230 installs and removes credentials on the at least one host 230 at the direction of the provisioning service 210. The credentials are obtained by the provisioning server 210 from the credentials server 220. The provisioning server 210 sends the necessary credentials to the server manager 230. The provisioning server 210 or the provisioning service determines the computing task that the guest host 202 is to do and also determines the credentials necessary to complete the computing task. In some embodiments, the provisioning server 210 provides no more credentials from the credential server 220 than is absolutely needed to the server manager 230. The guest host 202 is unable to request credentials directly from the credentials server 220. Upon completion of the computing task or upon an indication that the at least one guest host 202 of the virtual server 290 is going no further with the computing task, the provisioning server 210 acting through the server manager 230 removes the credentials previously provided to the at least one guest host 202 associated with the virtual server 290. In this way, the at least one guest server 202 has the credentials only as long as the at least one guest server 230 is executing the computing task. No credentials are left or saved on the guest host 202 shortly after completion of a computing task. This enhances security since there are no credentials left on the virtual server 290 that could be used to gain access to other information, such as data or instruction sets.

The credentials stored on the credential server 220 may include different types of credentials. For example, the credential server 220 can include access credentials, such as passwords, and encryption keys. The encryption keys are used to encrypt data. Data is encrypted with a private key. A public key is provided to a known entity. The known entity uses the public key along with the private key to decrypt the data. The credentials, in one example embodiment, are stored in a relational data base on the credentials server 220. In one embodiment, the credentials server 220 may be used for only one entity or client. In other embodiments, the credentials server 220 is used by multiple customers or clients. In this embodiment, each customer or client may be provided with different encryption keys specific to that customer. Identifying information is not stored along with the credentials database.

The provisioning server 210 provides credentials to the at least one guest server manager 202. The provisioning manager 210 determines the credentials needed by the at least one guest server manager 230 to perform a computing task and forwards them to the at least one guest server manager 230. The guest host 202 is unable to request the credentials directly from the credentials server 220. The at least one guest server manager 230 machine, acting under the direction of the provisioning server 210, removes credentials from the guest host associated with the virtual server. In one embodiment, the provisioning server instructs the server manager 230 to remove the credentials it has been provided when there is an indication that either the computing task is complete or when there is an indication that no more computing tasks will be conducted by the at least one guest host 202. In some embodiments, the provisioning service 210 monitors the at least one guest host by polling the guest server manager machine 230 associated with the at least one guest host 202.

FIG. 2 is a schematic of a computing system 200 for managing a virtual server 290, according to an example embodiment. This example embodiment differs from the example embodiment shown in FIG. 1 in that it shows multiple server managers on multiple servers within the cloud 100. The computing system 200 for managing a virtual server 290 includes a provisioning service machine 210 remote from the virtual server 290 that operates a provisioning service, a first guest server manager 233 running on a first guest host 202 associated with the virtual server 290, a second guest server 234 manager running on a second guest host 204 associated with the virtual server 290, and a credentials server 220 remote from the virtual server 290. The virtual server 290 is part of the cloud 100 or internet that is combined for the purpose of providing computing resources to perform a computing task. The provisioning server 210 obtains credentials from the credentials server outside the virtual server. Both the first server manager 230 and the second server manager 234 install and remove credentials on the first guest host 202 and the second guest host 204, respectively, at the direction of the provisioning service 230. The credentials are obtained by the provisioning service 230 from the credentials server 220. Neither the first guest host 230 nor the second guest host 234 is able to request credentials from the credentials server 220. In one embodiment, the provisioning service machine 210 and the credentials server 220 are remote from one another and from the virtual server 290. The provisioning service machine 210 provides the first server manager 230 with a set of credentials needed to perform a given operation on the first guest host 202. The first service manager 230 is directed to dispose of the set of credentials upon completion of the given operation. In one embodiment, the first server manager 230 includes an error handling component 231. The error handling component 231 enables removal of credentials from the first server manager 230 in the event of a failure. The failure may be any type of failure, including a failed operation. The server manager, such as server manager 230 or server manager 234, is capable of handling other types of tasks, including managing processes for encrypting file systems at the request of the provisioning service, and a process for backing up information at the request of the provisioning service, and the like. The computing system 200, as shown in FIG. 2, also includes a user interface 280 storing representations and producing signals enabling management of credentials in the credential server. In one embodiment, the user interface is a web browser, such as Internet Explorer, or Mozilla.

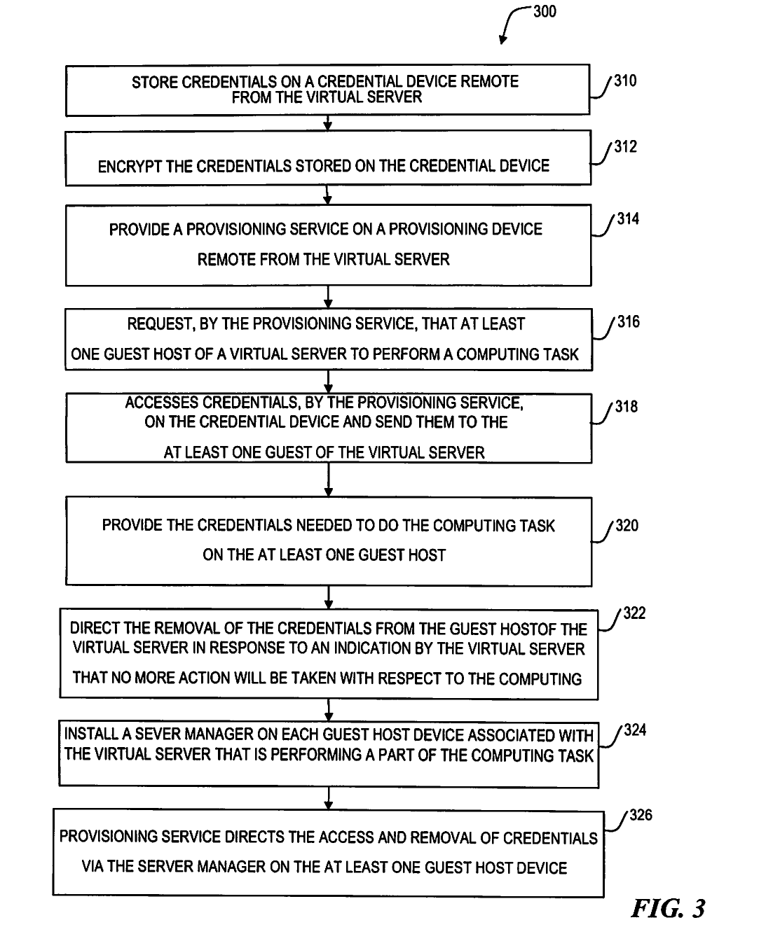

FIG. 3 is a flow diagram of a method 300 for managing security in a virtual server (such as virtual server 290 shown in FIG. 2), according to an example embodiment. The method 300 includes storing credentials on a credential device remote from the virtual server 310, encrypting the credentials stored on the credential device 312 and providing a provisioning service on a provisioning device remote from the virtual server 314. The provisioning service requests that at least one guest host of a virtual server to perform a computing task 316. The provisioning service accesses credentials on the credential device and sending them to the at least one guest of the virtual server 318. The provisioning service provides the credentials needed to do the computing task on the at least one guest host 320. The provisioning service also directs the removal of the credentials from the guest host of the virtual server in response to an indication by the virtual server that no more action will be taken with respect to the computing 322. The method 300 also includes installing a sever manager on each guest host device 324 associated with the virtual server that is performing a part of the computing task. The provisioning service directs the access and removal of credentials via the server manager on the at least one guest host device 326. Directing the removal of credentials via the server manager on the at least one guest host device 326 includes providing instructions to the guest host device via the provisioning device to dispose of the credentials in response to an indication that no more action will be taken with respect to completion of the computing task. No more action will take place if the computing task is complete or if a failure of some sort occurs.

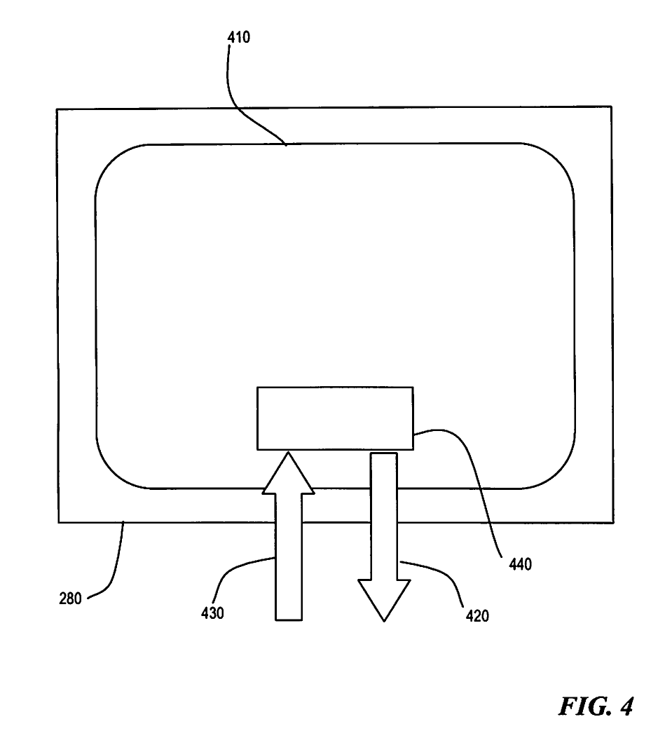

A computing system 200 includes a communications network 203 having a communication device 280 operatively coupled to a communications network 203. The computing system 200 includes a credential server device 220 operatively coupled to the communications network 203. Turning now to FIG. 4, the display device 280 is further detailed. The communication device 280 also includes a display component 410. The display component elicits a selection of at least one action to apply to a set of credentials stored on the credentials server. The at least one action is for managing the set of credentials on the credential service device. The display device also includes a signal output component for outputting signals related to the selected action 420, and a signal receipt component 430 for receiving signals regarding the selected action at the communications device. The communications device 280 displays an element 440 related to managing the credential server device. The element 440 elicits a response or responses from the user via changes in the element over time, such as when a user inputs one response, the element changes to elicit another response. A provisioning device 210 is attached to the communications network 203. The provisioning device 210 retrieves credentials from the credential server needed to complete computing tasks. The communication device 280 includes a graphical user interface. In some embodiments, the communications device 280 is a computer having a monitor which runs a WEB browser. The signal output component 420 and the signal receipt component 430 include signals related to the management of the credential server. In some embodiments, the signal output component and the signal receipt component also include signals related to the management of the provisioning device. In one embodiment, the communication device 280, the credentials server device 220, and the provisioning server device 210 are remote from a virtual server.

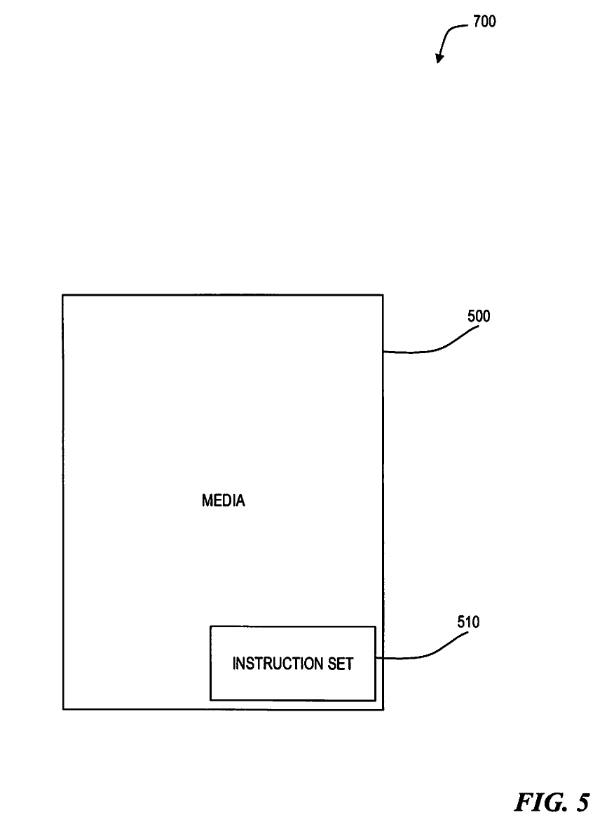

FIG. 5 is a schematic diagram of a media 500 that includes a set of instructions 510 according to an example embodiment. The machine readable media 500 includes any type of media including volatile memory, and non-volatile memory, removable storage, and non-removable storage. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer readable media 500 also includes the internet or an internet connection that allows access to a computing environment that includes any type of computer-readable media. The machine-readable medium 500 provides instructions 510 that, when executed by a machine, cause the machine to perform operations including storing credentials on a credential device remote from the virtual server, encrypting the credentials stored on the credential device, and providing a provisioning service on a provisioning device remote from the virtual server. The instruction set 510 causes the provisioning service to request the at least one guest host of a virtual server to perform a computing task, access credentials on the credential device and send them to the at least one guest of the virtual server. The instruction set causes the provisioning service providing the credentials needed to do the computing task on the at least one guest host, and to remove credentials from the guest host of the virtual server in response to an indication by the virtual server that no more action will be taken with respect to the computing. The instructions further cause the machine to perform operations such as installing a sever manager on each guest host device associated with the virtual server that is performing a part of the computing task, and directing the access and removal of credentials via the server manager on the at least one guest host device. The instructions further cause the machine to perform operations to direct the removal of credentials via the server manager on the at least one guest host device. The removal of credentials includes providing instructions to the guest host device via the provisioning device to dispose of the credentials in response to an indication that no more action will be taken with respect to completion of the computing task.

What is claimed:

1. A computing system for managing a virtual server comprising:
a machine remote from the virtual server that operates a provisioning service;
a credentials server remote from the virtual server, the provisioning service obtaining credentials from the credentials server outside the virtual server; and
at least one guest server manager running on a guest host associated with the virtual server, the server manager installing and removing credentials on the at least one host at the direction of the provisioning service, the credentials obtained by the provisioning service from the credentials server, wherein the guest host is unable to request credentials from the credentials server.

2. The computing system of claim 1 wherein the credentials stored on the credential server include access credentials.

3. The computing system of claim 1 wherein the credentials stored on the credential server include data encryption keys.

4. The computing system of claim 1 wherein the credentials server stores credentials as a relational data base, the credentials in an encrypted form.

5. The computing system of claim 1 wherein the credentials server includes:
a first set of credentials encrypted with a first encryption key; and
a second set of credentials encrypted with a second encryption key.

6. The computing system of claim 1 wherein the at least one guest server manager machine removes credentials from the guest host associated with the virtual server.

7. The computing system of claim 6 wherein the at least one guest server manager includes a set of error handling instructions to enable removal of the credentials even in response to a failed operation.

8. The computing system of claim 1 wherein the provisioning service monitors the at least one guest host by polling the guest server manager machine associated with the at least one guest host.

9. A computing system for managing a virtual server comprising:
a provisioning service machine remote from the virtual server that operates a provisioning service;
a credentials server remote from the virtual server, the provisioning service obtaining credentials from the credentials server outside the virtual server; and
a first guest server manager running on a first guest host associated with the virtual server; and
a second guest server manager running on a second guest host associated with the virtual server, wherein both the first server manager and the second server manager install and remove credentials on the first guest host and the second guest host, respectively, at the direction of the provisioning service, the credentials obtained by the provisioning service from the credentials server, wherein neither the first guest host nor the second guest host is able to request credentials from the credentials server.

10. The computing system of claim 9 wherein the provisioning service machine and the credentials server are remote from one another.

11. The computing system of claim 9 wherein the provisioning service machine provides the first server manager with a set of credentials needed to perform a given operation on the first guest host, the first service manager directed to dispose of the set of credentials upon completion of the given operation.

12. The computing system of claim 9 wherein the first server manager includes an error handling component, the error handling component enabling removal of credentials from the first server manager in the event of a failure.

13. The computing system of claim 12 wherein the failure includes a failed operation.

14. The computing system of claim 9 wherein the first server manager manages a process for encrypting file systems at the request of the provisioning service.

15. The computing system of claim 9 wherein the first server manager manages a process for backing up information at the request of the provisioning service.

16. The computing system of claim 9 further comprising a user interface storing representations and producing signals enabling management of credentials in the credential server.

17. A method for managing security in a virtual server, comprising:
storing credentials on a credential device remote from the virtual server;
encrypting the credentials stored on the credential device;
providing a provisioning service on a provisioning device remote from the virtual server, the provisioning service:
requesting at least one guest host of a virtual server to perform a computing task;
accessing credentials on the credential device and sending them to the at least one guest of the virtual server, the provisioning service providing the credentials needed to do the computing task on the at least one guest host;
removing credentials from the guest host of the virtual server in response to an indication by the virtual server that no more action will be taken with respect to the computing.

18. The method of claim 17 further comprising installing a sever manager on each guest host device associated with the virtual server that is performing a part of the computing task, the provisioning service directing the access and removal of credentials via the server manager on the at least one guest host device.

19. The method of claim 18 wherein directing the removal of credentials via the server manager on the at least one guest host device includes providing instructions to the guest host device via the provisioning device to dispose of the credentials in response to an indication that no more action will be taken with respect to completion of the computing task.

20. A computing system comprising:
a communications network;
a communication device operatively coupled to a communications network; and
a credential server device operatively coupled to the communications network, the communication device including:
a display component eliciting a selection of at least one action to apply to a set of credentials stored on the credentials server, the at least one action for managing the set of credentials on the credential service device; and
a signal output component for outputting signals related to the selected action; and
a signal receipt component for receiving signals regarding the selected action at the communications device, the communications device displaying an element related to managing the credential server device; and
a provisioning device attached to the communications network, the provisioning device for retrieving credentials from the credential server needed to complete computing tasks.

21. The computing system of claim 20 wherein the communication device includes a graphical user interface.

22. The computing system of claim 21 wherein the signal output component and the signal receipt component include signals related to the management of the credential server.

23. The computing system of claim 21 wherein the signal output component and the signal receipt component include signals related to the management of the credential server and the provisioning device.

24. The computing system of claim 20 wherein the communication device, the credentials server device, and the provisioning server device are remote from a virtual server.

25. A machine-readable medium that provides instructions that, when executed by a machine, cause the machine to perform operations comprising:
storing credentials on a credential device remote from the virtual server;
encrypting the credentials stored on the credential device;
providing a provisioning service on a provisioning device remote from the virtual server, the provisioning service:
requesting at least one guest host of a virtual server to perform a computing task;
accessing credentials on the credential device and sending them to the at least one guest of the virtual server, the provisioning service providing the credentials needed to do the computing task on the at least one guest host;
removing credentials from the guest host of the virtual server in response to an indication by the virtual server that no more action will be taken with respect to the computing.

26. The machine-readable medium of claim 25 that provides instructions that, when executed by a machine, further cause the machine to perform operations that further comprise installing a sever manager on each guest host device associated with the virtual server that is performing a part of the computing task, the provisioning service directing the access and removal of credentials via the server manager on the at least one guest host device.

27. The machine-readable medium of claim 26 that provides instructions that, when executed by a machine, further cause the machine to perform operations that further comprise directing the removal of credentials via the server manager on the at least one guest host device includes providing instructions to the guest host device via the provisioning device to dispose of the credentials in response to an indication that no more action will be taken with respect to completion of the computing task.
